(19) United States
(12) Patent Application Publication
(10) Pub. No.: US 2012/0189769 A1
(43) Pub. Date: Jul. 26, 2012

(54) METHOD AND APPARATUS FOR REFINISHING WOODEN FLOORS

(75) Inventors: Michael G. Kramer, Springdale, AR (US); Richard B. Strickland, Springdale, AR (US); D. Wayne Lee, Springville, TN (US)

(73) Assignee: Nilfisk-Advance, Inc., Plymouth, MN (US)

(21) Appl. No.: 13/438,489

(22) Filed: Apr. 3, 2012

Related U.S. Application Data
(63) Continuation of application No. 11/777,434, filed on Jul. 13, 2007, now abandoned.
Application No. 11/777,434 is a continuation-in-part of application No. 10/907,605, filed on Apr. 7, 2005, now abandoned.

(51) Int. Cl. B05D 3/12

(52) U.S. Cl. 427/140; 427/444

(57) ABSTRACT

A portable machine is used to abrade the surface of a factory finished wooden floor so the abraded surface may be recoated with a fresh coat of wooden floor finish. Abrasion of the surface provides anchor sites to achieve a strong bond between the pre-existing abraded finish and the fresh coat of wooden floor finish.

### CROSS REFERENCE TO RELATED CASES

This application is a continuation of and claims the benefit of priority under 35 U.S.C. §120 to U.S. patent application Ser. No. 11/777,434, filed on Jul. 13, 2007, entitled “METHOD AND APPARATUS FOR REFINISHING WOODEN FLOORS,” which is a continuation-in-part of application Ser. No. 10/907,605 filed on Apr. 7, 2005, the benefit of priority of each of which is claimed hereby, and each of which are incorporated by reference herein in its entirety.

### BACKGROUND OF THE INVENTION

Factory finished hardwood floors are a growing segment of the wood flooring industry. Factory finished wooden floors, often contain a resilient, wear-resistant topcoat and one or more intermediate coats that are applied to a thin upper veneer of wood. In contrast, conventional on-site finished wooden floors use solid wooden planks. Prior art sanding techniques and abrasive elements used successfully on conventional on-site wooden floors with solid wooden planks have been ineffective when applied to factory finished floors with a thin upper veneer of wood.

Some wood flooring manufacturers have incorporated wear-resistant particles into these factory applied finishes, as a means of giving their product a competitive advantage over solid plank wood floors that are finished on-site. The wear resistant particles in the finish allow factory finished floor manufacturers to provide long wear-through warranties. Traditional floor finishes that are applied on-site to solid plank wood floors typically do not contain wear resistant particles.

Some of the factory finished wooden floors have a nominally flat surface and some have an intentionally uneven surface which is often referred to in the trade as “sculptured”. These nominally flat and sculptured floors have their finish applied at the factory as opposed to the traditional method of having a contractor finish the floor on-site after installation. Many factory finished wooden floors also have a slight bevel on the opposing longitudinal edges which is another, reason why the surface is referred to as nominally flat.

Traditional wooden floors that are finished on-site are typically solid wooden planks that are about ¾ inch thick. These on-site finished floors may be sanded with a variety of prior art machines including but not limited to: walk-behind drum sanders, walk-behind belt sanders, walk-behind orbital sanders and/or walk behind rotary sanders. To applicants knowledge, none of the aforementioned prior art sanders use a brush with filaments having an impregnated abrasive to finish solid plank floors that are installed on-site.

The present invention produces an unexpected result when compared with prior art abrasive sleeves, abrasive belts, peel and stick sandpaper and abrasive screens. Wood floors have a grain that is derived from the tree. Some of the grain is hard and some of the grain is soft. The prior art abrasive sleeves, belts, sandpaper and screens are relatively flat to achieve a relatively flat finish on the floor. In other words, they are designed to sand relatively equal amounts of the hard and the soft grain. Some believed that a cylindrical brush, if used on wooden floors would remove more wood from the soft grain and less wood from the hard grain, thus leaving an uneven floor surface, which would be undesirable. Thus for decades, no one is believed to have used cylindrical abrasive brushes on conventional on-site solid wooden plank floors. Some thought that the cylindrical brush of the present invention would have a similar deleterious effect on factory finished wooden floors. In other words, some anticipated that a cylindrical brush would remove more soft grain than hard grain and leave an uneven floor surface, which is undesirable. Unexpectedly, the cylindrical brush of the present invention removes the same amount of finish and/or wood from soft grain and hard grain, on factory finished flooring, leaving a nominally flat surface. Unexpectedly, the cylindrical brush of the present invention, when used on uneven sculptured factory finished floors, does not destroy the sculptured surface.

The aforementioned prior art drum sanders often use replaceable abrasive sleeves that fit over the drum to sand conventional solid plank floors. These prior art abrasive sleeves often rotate from about 1,800 to about 3,000 rpm, which is much too fast for the brushes used in the present invention. These high speeds cause the filaments to fly off the brush of the present invention which limits brush life.

The brush of the present invention rotates from about 750 to about 950 rpm, and optimally about 850 rpm. The aforementioned prior art belt sanders often use circular abrasive belts to sand the floor. The belt sanders, likewise operate as speeds much too fast for the brush of the present invention. The aforementioned prior art orbital sanders often use replaceable peel and stick sandpaper sheets to sand the floor and orbit at about 175 rpm, which is too slow for the brush of the present invention. Orbital sanders also leave undesirable circular scratches in the surface of factory finished floors. The aforementioned prior art rotary sanders often uses replaceable abrasive screens that adhere to a polyester fiber pad to sand the floor. The replaceable screens are coated with an abrasive that functions to sand the floor. Rotary sanders typically operate at about 175 rpm, which as previously mentioned is too slow for the brush of the present invention.

Conventional wooden floors that are finished on-site are uneven and have high and low spots. However, because the planks are thick solid wood, aggressive sanding to eliminate many of the high spots is common using conventional procedures and conventional abrasive elements discussed above. However, factory finished floors have a thin upper veneer that often will not support the aggressive sanding techniques of conventional procedures with conventional abrasive sleeves, abrasive belts, sandpaper and/or abrasive screens. There is a need to develop new procedures and new apparatus that will allow refinishing of factory finished floors with thin upper veneers.

Factory finished hardwood floors come in various thicknesses, but ⅜ inch is common. The thin upper veneer on the factory finished wooden floor may only be 0.125-0.05 inches thick for ⅜ inch flooring. Thicker factory finished hardwood floors of 9/16 inch may only have a upper veneer of 0.160-0.05 inches. The wood under the top veneer is often of a different type or grade to reduce the cost of the factory finished flooring. Conventional walk-behind drum sanders with prior art abrasive sleeves, walk-behind belt sanders with prior art abrasive belts, orbital sanders with prior art peel and stick sandpaper and/or rotary sanders with prior art abrasive screens may sand through the thin veneer of factory finished floors, especially at “high spots” which are discussed below. There is a need for an improved apparatus and method to refinish factory finished wooden flooring to, inter alia, avoid sanding through the thin veneer on high spots.

Various attempts by others have been made to develop ways to recoat and restore the luster to the finish of factory finished wood floors. For example, U.S. Pat. No. 6,663,467 is for a Process and Composition for Abrading Factory finished Floors. This prior art patent discloses an abrading composition that is applied to an area of floor, such as from a spray pump bottle. The wet floor is then either hand abraded with a pad in circular motion or gone over with a rotary buffing machine having a buffing pad.

Another attempt to recoat factory finished floors has been made by BonaKemi USA, Inc. of Aurora, Colo. The BonaKemi web site (www.bonakemi.com) advertises the Prep™ recoat adhesion system. The web site describes this product as a specially formulated recoat adhesion system for all types of polyurethane finished hardwood floors, including factory finished floors. According to this web site, the system conditions and prepares the existing finish to optimize adhesion of the new coat of finish.

Another attempt to recoat factory finished floors has been made by Basic Coatings of Des Moines, Iowa. The Basic Coatings website (www.basiccoatings.com) advertises the TyKote Dustless Recoating System as a product suitable for factory finished floors. Material from Basic Coatings describes the process as follows: The surface of the factory finished wooden floor is cleaned with Intensive Floor Treatment, another Basic product, followed by a clear water rinse and cleaning with Squeaky Cleaner, another Basic product. The TyKote bonding agent is then applied to the remaining floor finish and left to dry for an hour or so. Once the TyKote bonding agent is dry the wood floor finish can be applied. However, there is still a need for a better way to solve the problem of worn factory finished wooden floors.

Factory finished floors that come with a nominally flat finish may actually vary up or down by as much as ⅛ of an inch due to irregularities in the sub-floor. Sculptured factory finished floors have intentional irregularities in the surface, for example to give the appearance of a distressed appearance. The process and apparatus of the present invention can be used for several different applications on both nominally flat factory finished wooden floors and sculptured factory finished wooden floors.

### SUMMARY OF INVENTION

This invention is an apparatus and method that may be use for several applications including: 1) Restoring the luster to nominally flat and sculptured factory finished wooden floors; 2) Restoring the luster to a first site installed finish on nominally flat and sculptured wooden floors that were originally installed with a factory finish; 3) Removing the factory finish from nominally flat and sculptured factory finished wooden floors and refinishing, 4) Removing the first site installed finish from nominally flat and sculptured wooden floors that were originally installed with a factory finish and refinishing and 5) Removing a combined on-site finish and a factory finish from nominally flat and sculptured wooden floors and refinishing.

This invention is a portable machine with a brush having flexible filaments impregnated with a suitable abrasive and various methods for use of this machine on factory finished floors. There are various pitfalls to avoid when dealing with factory finished floors. When the objective is to restore the luster to a factory finish, it is undesirable to remove all of the existing factory finish. The challenge is to avoid abrasion of “high spots” down to bare wood, which will be discussed in greater detail below. In the alternative, when the objective is to remove the factory finish down to bare wood for refinishing, the challenge is to avoid abrasion of “high spots” through the thin upper wooden veneer, as will be discussed in greater detail below.

The present invention uses an easily removable brush with flexible filaments impregnated with suitable abrasives to abrade the surface of the floor. As the brush wears, fresh abrasive is exposed, giving the brush longer life. The brush may also be reversed on the drive shaft to give it longer life. The abrasives are selected from the group including aluminum oxide, silicon carbide and mixtures thereof. To applicant's knowledge, removable brushes with flexible abrasive impregnated filaments are not used to finish wooden floors in prior art on-site installations with solid plank floors. Prior art on-site methods utilize various abrasive elements including: replaceable abrasive drums, replaceable abrasive belts, replaceable sandpaper and/or replaceable abrasive screens which can be quickly dulled by factory finished floors. The prior art abrasive elements were replaced when the abrasive became dull or damaged. The removable brush of the present invention is designed to be easily removed from the machine and changed to another grit to suit the needs of the operator.

A. Restoring the Luster to a Floor Finish.

The process to restore the luster to the floor finish does not require removing all the finish down to bare wood. Instead, some of the existing finish is removed and some of the existing factory finish is left on the floor surface. Microscopic scratches are made in the remaining factory finish to provide anchor sites to achieve a good bond between the pre-existing abraded finish and the new coat and/or coats of wood floor finish. The challenge is to avoid abrading all the way through the factory finish down to bare wood.

The floor unevenness will create “high spots” and “low spots” in the floor surface. Both of these conditions are a challenge when it is time to restore the luster to a factory finished floor. When the filaments of the abrading brush of the present invention encounter “high spots” they bend so the finish on this portion of the floor is not abraded down to bare wood. In the case of “low spots”, the abrading brush is designed with filaments long enough to reach into and sufficiently abrade the finish in “low spots” that would be encountered on a typical floor.

Conventional processes which use abrasive sleeves, abrasive belts, peel and stick sandpaper and/or abrasive screens do not perform well on factory finished floors which contain “high spots” and “low spots”. When a drum sander with an abrasive sleeve encounters a “high spot” on the floor, it tends to completely remove the finish of a factory finished wooden floor down to the bare wood on the high spot and not necessarily the surrounding floor surface. Similar results may also occur with belt sanders using abrasive belts, orbital sanders using sandpaper and/or rotary sanders using abrasive screens. When restoring the luster to a factory finished floor, it is undesirable to abrade the finish down to bare wood on just the “high spots” because the overall floor coloring is no longer uniform and may need to be restained. It is difficult and often impossible to restain an exposed “high spot” to match the rest of floor. Further, it is time consuming and adds to the expense of the project. When a conventional drum sander with abrasive sleeves, a belt sander with an abrasive belt, an orbital sander with peel and stick sandpaper and/or rotary sander with abrasive screens encounters a “low spot” it may pass right over the area without ever abrading the finish. Once the new top coat of finish is applied, it is unlikely that the finish will adhere properly to the under coat of finish in the area of the “low spot” because little or no abrasion has occurred to allow for a mechanical bond to take place between the two coats of finish.

B. Removing the Existing Finish Down to Bare Wood and Refinishing the Surface.

If the factory finish is badly damaged by wear, sun bleaching or water, it may be necessary to remove the factory finish and stain down to the bare wood so a new finish can be installed on-site. The challenge is to avoid abrading through the thin top wooden veneer. The abrading brush used in the present invention has flexible radial filaments impregnated with abrasive particles. As the brush wears, fresh abrasive particles are exposed. Most floors are slightly uneven, even installed factory finished floors, due to the uneven sub-floor or minor variances in the wood thickness and manufacturing tolerances.

When it is necessary to remove the factory finish down to bare wood and refinish, the operator still is concerned with high and low spots, because it is possible to unintentionally wear through the thin top veneer of wood, down to lower, lesser quality wood on factory finished floors. If the thin top veneer is unintentionally worn through, the plank of wood will need to be removed from the floor. This is costly and time consuming. Further, unless some of the original factory finished planks of wood are kept as spares by the homeowner, it may be difficult to match the exact height and size, even though they may be produced to a standard.

Various types of conventional drum sanders may be modified and used in the present invention. Many of the following drum sanders operate in the range of about 1,800 to about 3,000 rpm. This is too fast for the present invention because the filaments will fly off the removable cylindrical brush or break off, thus reducing the brush like. The brush speed of the present invention is from about 750 to about 950 rpm, and optimally about 850 rpm. If any of the following drum sanders are modified, to be used in the present invention, the brush speed will also need to be reduced. This can easily be accomplished with a motor change-out or through the use of different pullys. Further, these conventional drum sanders will need to be refitted with an appropriate drive shaft, and a suitable abrading brush.

| Model | Source |
|---|---|
| EZ-8 | Clarke Division of ALTO U.S. Inc. in |
| | Springdale, Arkansas, U.S.A. |
| Handy 8 and Handy 8E | Quide S.A. |
| | Deva, Guipuzcoa, Spain |
| Scorpion and Libra | Künzle & Tasin S.p.A. |
| | Milano, Italy |
| | Künzle & Tasin U.S. Inc. |
| | Fort Lee, New Jersey, U.S.A. |
| Profit | Eugen Lägler GmbH |
| | Guglingen - Frauenzimmer, Germany |
| Standard 8 | Bonakemi AB |
| | Malmö, Spain |
| 506 | Galaxy Floor Abrading Machines |
| | Toronto, Ontario, Canada |
| 5L-8* | Essex Silver-Line Corp. |
| | Dracut, Massachusetts, U.S.A. |
| HT8-1.2* | Hire Technicians Group Ltd. |
| | Watford, Herts, United Kingdom |

*The machines denoted with an asterisk have two wheels and the machine tips back to raise the machine out of contact with the floor and tips forward to lower the machine into contact with the floor for abrading. The other machines listed above have a lever mechanism like the EZ-8 that raises the machine out of contact with the floor and lowers the machine into contact with the floor for abrading. Those skilled in the art are familiar with both of these designs, i.e. the lever mechanism and the tip forward design. The EZ-8 operates at about 1800 RPM; some of the other machines listed above operate at about 2800 RPM which will need to be reduced to accommodate the removable cylindrical brush of the present invention.

### BRIEF DESCRIPTION OF DRAWINGS

FIG. 1 is a perspective view of a floor abrading machine for removing a factory finish and/or restoring the luster to prefinished factory floors.

FIG. 2 is a right side elevation view of the floor abrading machine of FIG. 1 with the front cover in the open position exposing a floor abrading brush.

FIG. 3 is a perspective view of the left side of the floor abrading machine of FIG. 1 with the front cover in the open position exposing the floor abrading brush.

FIG. 4 is a front elevation view of the floor abrading machine of FIG. 1 with the front cover in the open position exposing the floor abrading brush.

FIG. 5 is a bottom perspective view of the floor abrading machine of FIG. 1.

FIG. 6 is an end view of a tufted abrading brush with fine grit.

FIG. 7 is a top perspective of a single tuft of filaments from the brush of FIG. 6.

FIG. 8 is a perspective view of a tufted abrading brush with course grit.

FIG. 9 is and end view of the tufted abrading brush of FIG. 8.

FIG. 10 is a perspective view of the abrading brush of FIG. 2 with fine grit and filaments in a random array.

FIG. 11 is an end view of the brush of FIG. 10.

FIG. 12 is a partial section view of the brush and apparatus in FIG. 2 having a spring and internal pocket to receive a roll pin.

FIG. 13 is an end view of the brush hub of FIG. 12, better showing the internal pocket in phantom and the cutout for the roll pin.

, FIG. 14 is a partial section view similar to FIG. 12, with an internal pocket to receive the roll pin, but the spring has been replaced with a shoulder on the drive shaft.

FIG. 15 is similar to FIG. 12, except the hub has an exterior pocket to receive the roll pin.

FIG. 16 is an end view of the inner hub of FIG. 15 showing the external pocket and the cutout for the roll pin.

FIG. 17 is similar to FIG. 12 except there is no screw and washer to hold the brush on the drive shaft. This is the easy on-easy off design that does not require tools to remove the brush from the drive shaft.

### DETAILED DESCRIPTION

Factory finished wood flooring is currently offered by many manufacturers using a variety of different manufacturing techniques. One manufacturing technique involves a long production line described below. Multiple strips of bare wood are put on a long conveyor and run under a belt sander. A stain may then be applied to the bare wood after it has been abraded. After the stain is applied, hair like fibers (sometimes called “nibs” in the industry) may be raised up in the wood grain. The strips of stained wood with raised nibs are sometimes run through a stationary denibbing machine with an abrasive abrading brush (sometimes called “a denibbing brush” in the industry). The brush speed in some of these prior art stationary sanders is believed to be in the range of about 100 to about 200 rpm. A base coat of wood sealer is then applied.

The base coat of sealer may raise additional nibs. Again, the strips of stained, sealed wood with raised nibs are sometimes run through another denibbing machine having a denibbing brush to knock down the nibs and abrade off excess sealer without breaking through the base coat to bare wood. Contractor grade factory finished wooden floors may have several intermediate coats of finish and a topcoat. Higher quality factory finished wooden floors may have 10 or more intermediate coats of wood finish and a topcoat. The intermediate coats and topcoat are applied sequentially on one long conveyor. The first intermediate coat of finish is applied to the slats. The slats go under an ultra-violet cure lamp which causes cross-linking in the first intermediate coat of finish. After curing, the slats run through a stationary sander with denibbing brushes, but the purpose of this step is not to remove nibs. Instead the purpose is to abrade the surface of the first intermediate coat to achieve a good bond with the second intermediate coat. Subsequent intermediate coats go through the same steps: apply a coat of finish, cure and abrade. Finally comes the topcoat which runs under the cure lamp to harden the surface and achieve cross-linking. However, the topcoat of finish is not run through a stationary abrading machine like all the prior coats of finish.

The prior art denibbing brushes used by prefinished floor manufacturers may be fabricated from DuPont “Tynex A” filaments. (Tynex is a trademark owned by DuPont for nylon filament often used in brushes.) These prior art brush filaments are about 70% nylon and are impregnated with about 30% abrasives. Applicants use similar filaments in the present invention that are impregnated with abrasives. Other filaments that have abrasives adhered to the exterior of the filament or impressed into the exterior surface of the filament may also be suitable for use with this invention. Prior art brush designs vary among different manufacturers. Some prior art denibbing brushes have filaments that are 1″ to 1⅝″ long with a filament density of 100-110 filaments per square inch and a grit of 180. Makers of the denibbing brushes sometimes recommend that they be operated with an optimal deflection of 0.030 to 0.045 inches. These prior art denibbing brushes are about 8 feet long and the filaments are arranged on a angle so they sweep across the wood. Because of this angle, these brushes are only capable of rotating in one direction.

Applicants have tested several types of removable cylindrical brushes for use in the present invention and have determined that certain types of brushes are suitable to restore the luster to factory finished wooden floors after they have been installed and become worn and/or remove a factory finish down to bare wood on the thin top veneer for refinishing. The prior art denibbing brushes described above are used in a closely controlled factory environment in a stationary sanding machine. In contrast, the abrading brushes of the present invention are used on-site, in portable abrading machines, typically in homes, hotels, restaurants and other locations where wood flooring has been installed. The prior art denibbing brushes were about 8 feet long; the removable cylindrical brush of the present invention is about 8 inches long. The prior art denibbing bushes would only run in one direction because the filaments were on an angle. The brush of the present invention can operate in two directions because the filaments are arranged radially.

In the factory environment, the manufacturer has no concern for high or low spots, because they begin the manufacturing process with sufficient wood to develop a factory finish. In a factory, the manufacturer can carefully control the amount of wood/finish that is being removed. On-site, such delicate controls are not available. On site, a contractor must be concerned with high and low spots to avoid unintentionally abrading down to bare wood or abrading through the thin top veneer, depending on the type of process that is underway.

In the factory, the prior art denibbing brushes are used to build up a finish on a thin layer of wood veneer to produce what has previously been referred to as factory finished flooring. The present invention uses abrading brushes in an opposite fashion to remove one or more layers of finish, sometimes down to the thin layer of veneer.

In the factory, the wood moves under the prior art stationary sanding machine. In the present invention, the brush and the portable machine move over the floor surface and are taken from job site to site. The filaments in the prior art denibbing brushes are placed at an angle and therefore the can only be operated in one direction which limits brush life. The filaments in the brush of the present invention project radially from the center of the brush and therefore, it can run in both a clockwise and a counter-clockwise direction, doubling the life of the brush.

Brushes having the following characteristics are believed to be suitable for use in the present invention:

TABLE 1

| | Course | | Medium | | Fine | |
|---|---|---|---|---|---|---|
| | Range | Optimal | Range | Optimal | Range | Optimal |
| Filament Grit | 40-60 | 40 | 60-100 | 80 | 100-180 | 120 |
| Filament Diameter | .90-.040 | .090 | .090-.040 | .040 | .040-.035 | .035 |
| (inches) | | | | | | |
| Filament Length | .625-1.625 | 1.25 | .875-1.625 | 1.625 | .875-1.625 | 1.25 |
| (inches) | | | | | | |
| Filament Population | 10-35 | 15-25 | 60-120 | 70-90 | 60-120 | 70-90 |
| #/inches² | | | | | | |
| Down Force Lbs/inch | 3.50-8.00 | 4.38-6.88 | 3.50-8.00 | 4.00-4.63 | 3.50-5.00 | 4.00-4.63 |

The various properties of the filaments and the brush described in Table 1 are recommended, but may not be essential to successfully practice this invention. The down force on the brush is enough to cause a slight bend or deflection in the filaments when the abrading machine is in operation. The filaments deflect about 1/32 to about 1/16 inch. The deflection avoids abrading all the finish off the high spots in the floor as will be discussed in greater length below. If the resultant force on the brush is increased, the filament length can be shortened or the filament population can be increased, or a combination of both. The adjustment of these parameters is required to achieve a slight deflection in the filaments when the machine is in operation. Some abrading brushes that can be used in the present invention have filaments that are arranged, more or less, evenly about the brush core; other suitable abrading brushes that can be used in the present invention have tufts of filaments that are positioned in holes in the brush core. Both designs are suitable for use in the present invention. Factory finished wooden floors have a tough finish which is often due to the presence of wear-resistance particles in the finish. Conventional abrasive elements, such as abrasive sleeves, abrasive belts, peel and stick sandpaper and abrasive screens tend to rapidly wear out when applied to a tough factory finish. It is believed that the wear-resistant particles present in the finish of a factory finished wood floor quickly dull the conventional abrasive elements faster than conventional floor finishes that lack wear resistant particles. The wear-resistant particles that are believed to be used in factory finished wood flooring include, but are not limited to, aluminum oxide, carborundum, quartz, silicon carbide, glass particles, glass beads, glass spheres (hollow and/or filled), plastic grits, diamond dust, hard plastics, reinforced polymers, organics, and the like, or mixtures thereof. A floor abrading brush with wear resistant particles impregnated in the flexible filaments or with wear resistant particles adhered to the exterior of the filaments or impressed in the exterior of the filaments may be suitable for use with a floor abrading machine of the present invention.

In other applications, brushes with abrasive impregnated filaments are used to clean concrete floors and or escalators. However, to applicants' knowledge cylindrical brushes with abrasive type filaments that are used for floor cleaning have never been used, before the present invention, to condition factory finished wooden floors after they have lost their luster or have been damaged by wear, sunlight, or water.

ALTO U.S. Inc. the assignee of the present patent application currently makes and sells various types of sanders for wooden floors including: the Super 7R™, a hand held edger that is used around the walls and in other hard to reach areas and larger floor sanders such as the FloorCrafter™ a professional grade drum sander, the 3DS™, a rotary type fine finish sander that uses abrasive screens and sandpaper sheets, the OBS 18™, an orbital sander that uses sandpaper sheets and abrasive screens, the American 8™ a drum type sander that uses abrasive sleeves, and the EZ-8™ a drum type sander that uses abrasive sleeves. The EZ-8 sander can be rented at many of the Home Depot® stores around the country. Most of these sanders, including the EZ-8 have dust'control systems.

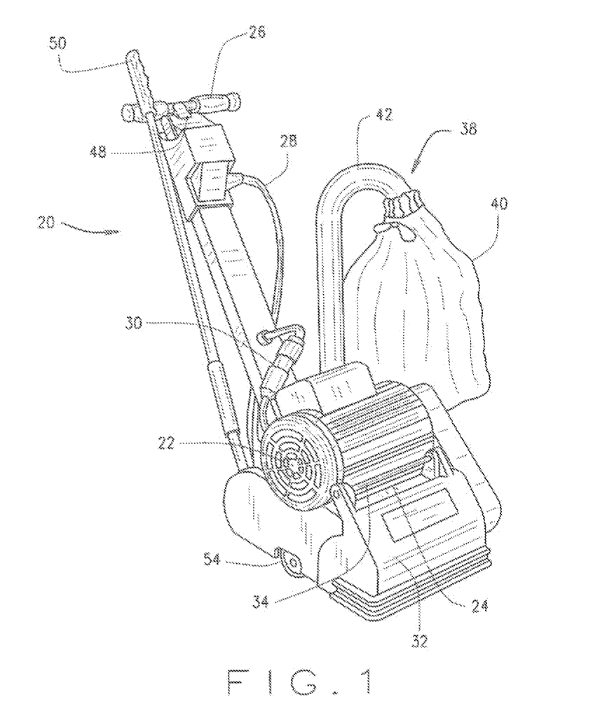

The following figures of the EZ-8 are described in general terms familiar to those in the wood flooring industry. FIG. 1 is a perspective view of a floor abrading machine generally identified by the numeral 20 that is suitable for restoring the luster to prefinished factory floors. A motor 22 is mounted on the frame 24. The motor in the prior art EZ-8 rotates the abrasive sleeve at about 1800 rpm. In the present invention, a different motor has been installed to achieve a brush speed of about 850 rpm. A removable handle 26 is also mounted on the frame. An electric cord 28 runs from the handle to the motor and includes a set of connectors 30 so the handle can be removed from the frame to facilitated storage and transport.

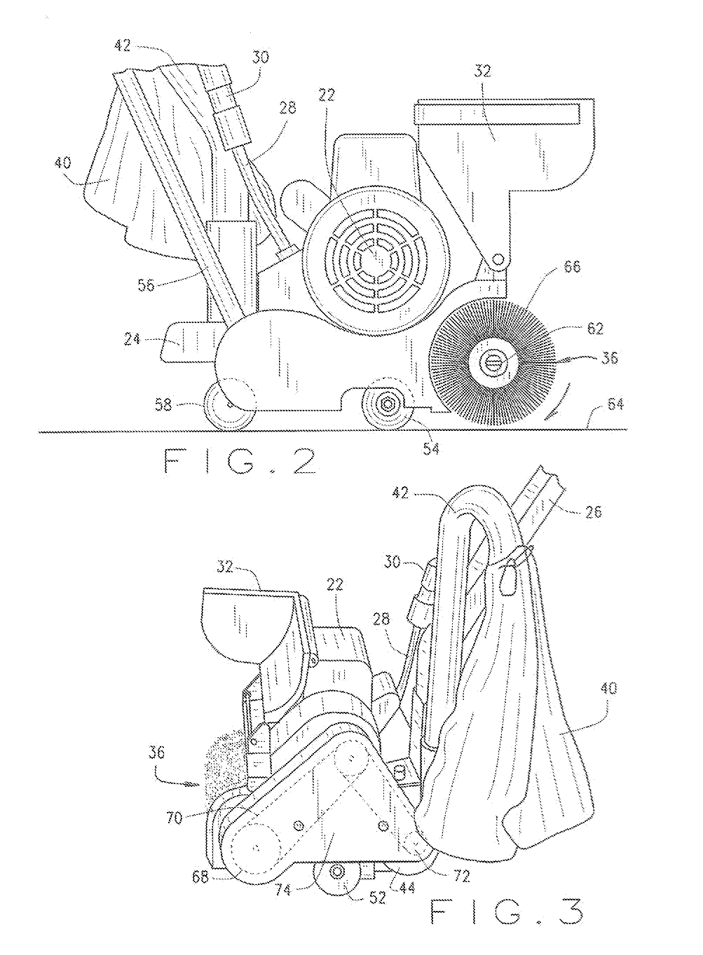

The front cover 32 is pivotally mounted on a shaft 34. The front cover has two positions. The lower position shown in FIG. 1 and the raised position shown in FIG. 2. The lower position is the operating position for abrading the floor. The raised position of FIG. 2 is to replace the removable floor abrading brush 36, better seen in FIG. 2.

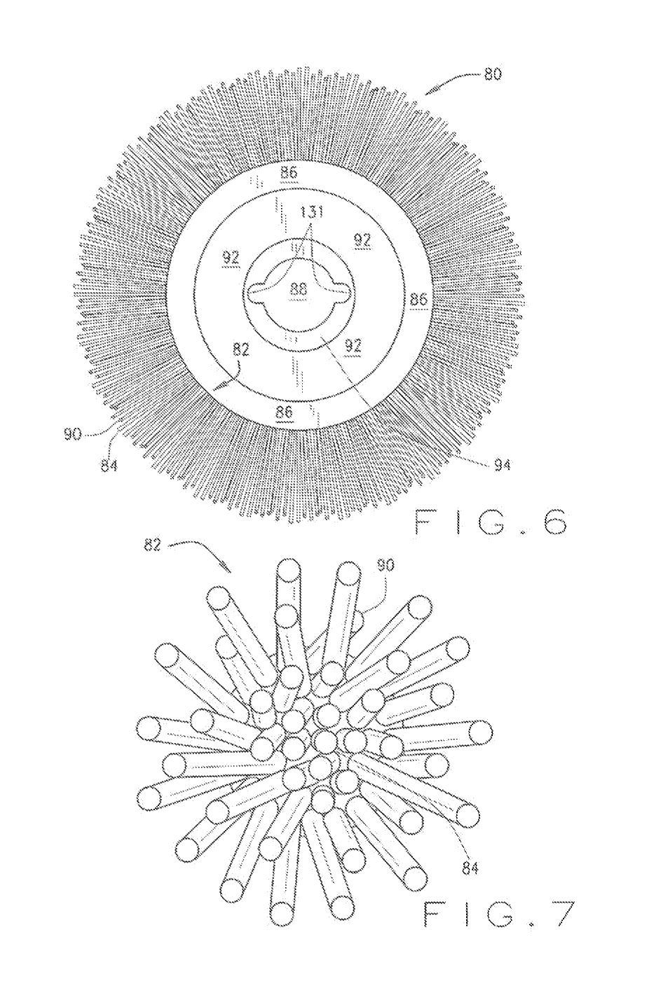

While the floor abrading machine is in operation, dust is created during normal operation. This is also true of sanders, as anyone knows who has had a conventional wooden floor refinished in their home. Dust control systems are therefore common on sanders and will also be necessary on this floor abrading machine during normal operations. The dust control system is generally identified by the numeral 38 and includes a removable dust collection bag 40, a rotatable dust conduit 42, a vacuum fan 44, better seen in FIG. 5 and dust collection pan 46 also better seen in FIG. 5. The dust is collected in the pan, moves through the vacuum fan, through the dust conduit and into the dust collection bag. The dust in the bag should be emptied anytime the floor abrading machine is turned off because the dust can spontaneously combust. An on/off switch 48 is mounted on the handle. A power cord, not shown, connects on one end to the electric cord 28 and on the other end to a source of electricity, not shown to power the motor 22.

A lever 50 is used to simultaneously raise and lower the left wheel 52 and the right wheel 54, better seen in FIG. 5. A raising and lowering assembly, generally identified by the numeral 56 and better seen in FIG. 2 or FIG. 5 connects the lever 50 to the wheels 52, 54. A caster 58, better seen in the next figure is mounted on the rear of the frame 24. The position of the caster is fixed relative to the floor 64.

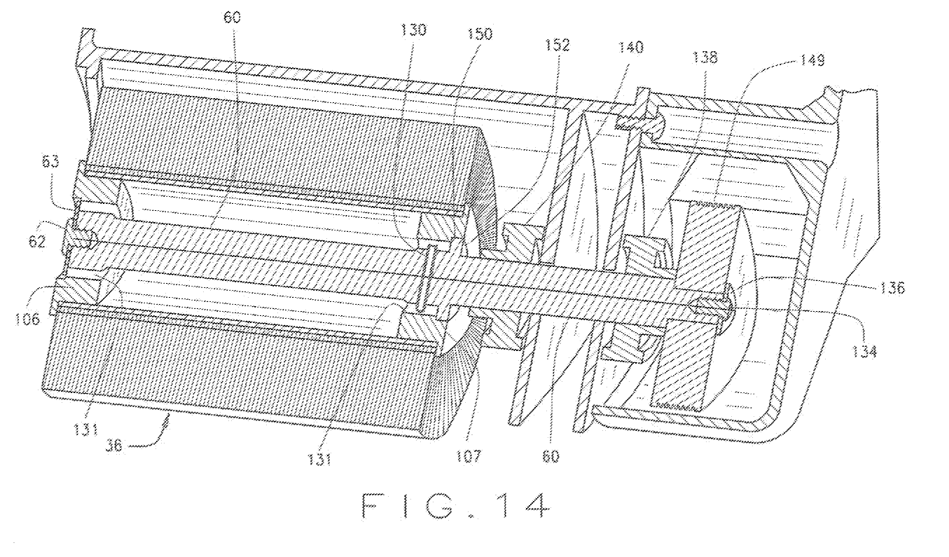

FIG. 2 is a right side elevation view of the floor abrading machine of FIG. 1 with the front cover 32 in the open position exposing a removable floor abrading brush 36. The brush mounts on a drive shaft 60, better seen in FIG. 12, and is secured by a bolt 62 which threadably engages the end of the drive shaft 60. A washer 63, better seen in FIG. 12 may be positioned between the bolt and the end of the drive shaft 60. To remove the brush, the bolt is removed and the brush slips off the drive shaft. The motor 22 is operatively connected to the drive shaft 60; when the motor rotates, the drive shaft rotates and causes the brush to spin relative to the floor 64 in the direction of the arrow.

The wheels 52, 54 can be adjusted from a lower position as shown in FIG. 2 to a raised position, not shown. In the lower position, the wheels 52, 54 and the caster 58 keep the brush from engaging the floor 64. When the lever 50 is lowered, the raising and lowering assembly 56 retracts the wheels 52, 54 about ½ inch causing the brush to engage the floor 64. In order to abrade the floor 64, the wheels 52, 54 must be retracted. As previously mentioned, the position of the caster 58 is fixed relative to the floor and is not effected by actuation of the lever or the raising and lowering assembly 56.

The removable cylindrical brush 36 has a plurality of flexible filaments 66 that radiate away from the center of the brush, as shown. The filaments 66 are impregnated with abrasive particles. Tynex A abrasive filaments from DuPont are believed to be suitable for this application.

FIG. 3 is a perspective view of the left side of the floor abrading machine of FIG. 1 with the front cover 32 in the open position exposing the floor abrading brush generally identified by the numeral 36. The motor 22 has a drive shaft and a double pulley mounted thereon, not shown. A brush pulley 68, shown in phantom is connected to the brush drive shaft 60, not shown. A brush belt 70, also shown in phantom is operatively connected to the double pulley, not shown on the drive shaft of the motor, not shown. Thus when the motor rotates, the motor drive shaft, not shown, rotates and so does the double pulley, not shown, which rotates the brush belt 70 and the brush pulley 68, both shown in phantom, the drive shaft 60, better seen in the preceding figure and the brush 36.

A fan pulley 72, shown in phantom is connected to the fan drive shaft, not shown. A fan belt 74, also shown in phantom is operatively connected to the double pulley, not shown on the drive shaft of the motor, not shown. Thus when the motor rotates, the motor drive shaft, not shown, rotates and so does the double pulley, not shown, which rotates the fan belt 74 and the fan pulley 72, both shown in phantom and the vacuum fan 44.

The vacuum fan 44 creates a vacuum in the collection pan 46 to suck up the dust and abrasive particles. The dust moves and abrasive particles move from the collection pan 46, through the vacuum fan 44, the rotatable dust conduit 42 into the dust collection bag 40. As previously mentioned, the dust collection bag should be removed from the rotatable dust conduit to empty the dust when the machine is turned off.

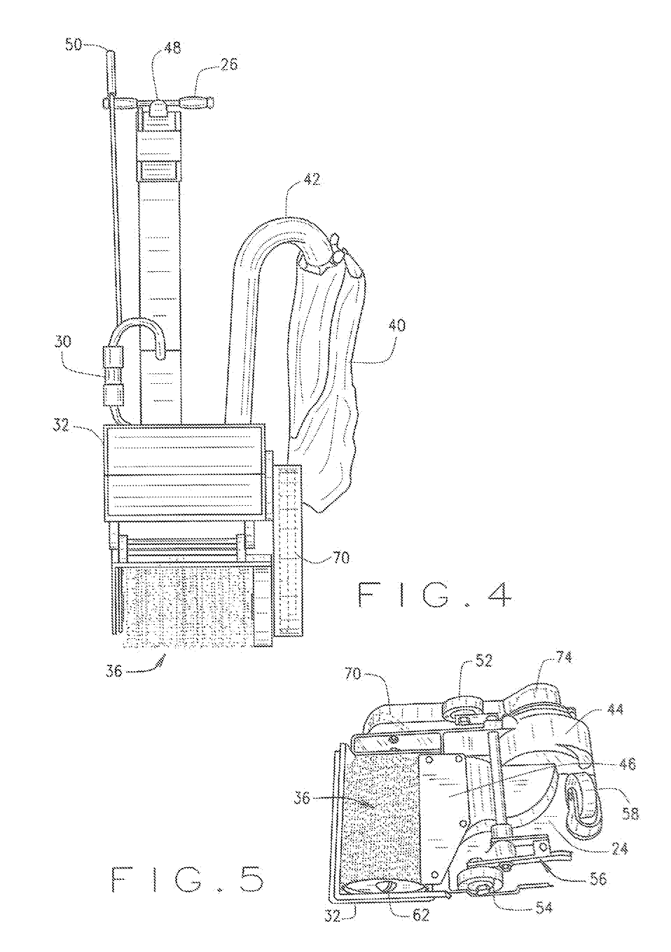

FIG. 4 is a front elevation view of the floor abrading machine of FIG. 1 with the front cover 32 in the open position exposing the floor abrading brush 36. The brush belt 70, shown in phantom drives the brush 36 as previously discussed. The dust and abrasive pass through the dust conduit 42 and are collected in the removable dust collection bag 40. The on/off switch 48 is positioned in a convenient location on the handle 26. The lever 50 raises and lowers the left wheel and the right wheel, not shown in this figure.

FIG. 5 is a bottom perspective view of the floor abrading machine of FIG. 1. As previously discussed the brush belt 70, shown in phantom drives the abrading brush 36 and the fan belt 74, shown in phantom drives the vacuum fan 44. When the floor abrading machine is in operation the vacuum fan creates a suction in the collection pan 46 which sucks up dust and abrasive particles which pass through the fan 44 and into the rotatable dust conduit 42 better seen in FIG. 4. The dust and abrasive particles come to rest in the dust collection bag 40 better seen in FIG. 4.

The frame 24 is raised and lowered by movement of the lever 50, better seen in the preceding figure. In FIG. 4, the lever 50 is shown in the upper position which raises the brush 36 out of contact with the floor 64. When the lever is lowered the raising and lowering assembly 56 retracts the wheels 52 and 54 about ½ inch which causes the frame 24 to lower to the floor thus engaging the filaments 66 of the brush 36 with the floor 64. The caster 58 is fixed and does not move up and down in response to actuation of the lever 50.

Example 1 and 2 are summarized in Table 2 below.

TABLE 2
Recommended Procedures for Nominally flat & Sculptured Floors

| | | | | |
|---|---|---|---|---|
| Example 1 | Med.—fine | Apply at | Med.—fine | Apply |
| Restoring luster to | grit | least one | grit | top |
| nominally flat floors | | intermediate | | coat |
| and sculptured | | coat | | |
| floors with factory | | | | |
| finish | | | | |
| Example 2 | Med.—fine | Apply at | Med.—fine | Apply |
| Restoring luster to | grit | least one | grit | top |
| on-site installed | | intermediate | | coat |
| finish for nominally | | coat | | |
| flat & sculptured | | | | |
| floors | | | | |

### Example 1

### Restoring the Luster to a Factory Finished Wooden Floor

This process is suitable for factory finished wooden floors having a nominally flat surface and those having a sculptured surface. Example 1 is summarized in Table 2 above. Typically the finish of the factory finished wood floor is cleaned using any of a variety of procedures such as vacuuming with a soft brush to remove dirt and dust. Another cleaning procedure is to dry mop or “tack” the finish in addition to or in lieu of vacuuming. A light spray cleaner may also be applied to the dry mop to help pick up dust and dirt.

The topcoat of the factory finished wooden floor is then abraded using the brush and the floor abrading machine described herein using a brush with flexible filaments having medium to fine grit. The operator should look for sufficient “powdering” during the abrasion process. Different types of finish will require different grit sizes and proper selection should be determined on-site. Assume the operator starts out with a brush having 80 grit. If there is no powdering, the operator should go to a brush with larger size grit, such as 60. If there is excessive powdering, the operator should go to a brush with smaller size grit, such as 100. When restoring the luster to a factory installed finish, the goal is merely to put small scratches, or abrasions in the factory finish, not to remove the finish down to bare wood. As previously mentioned, the small scratches improve adhesion of a fresh coat of finish.

If the topcoat is badly damaged or non-existent, one or more of the intermediate layers of finish may be abraded using the floor abrading machine. The edge portions of the floor not abraded by the floor abrading machine are then abraded by hand using abrading paper with medium to fine grit. The portions that have been clone by hand are often referred to as “edges”, “wall edges” or “wall lines” in the industry.

The abraded floor surface is then cleaned using any or all of the aforementioned procedures to remove dust and abrasive particles. A fresh coat of wooden floor finish is then applied to the abraded factory floor finish and allowed to dry, in accordance with the floor finish manufacturer's instructions, specific to each brand.

After drying, the at least one intermediate coat of finish is abraded with a brush having filaments with medium to fine grit. One or more intermediate coats may be applied followed by abrasion. A new topcoat of finish is applied and allowed to dry. After drying, the luster of the wooden floor has been restored and the floor is ready for use.

### Example 2

### Restoring the Luster to a First Site Installed Finish that is Nominally Flat or Sculptured

This process is the same for nominally flat surfaced factory finished wooden floors and those having a sculptured finish. Example 2 is summarized in Table 2 above. Example 2 assumes that the process of Example 1 has been applied to a factory installed wooden floor finish and that several years have passed with concomitant wear on the first site installed finish. It may then be appropriate to restore the luster to the first site installed finish as follows.

The surface of the wood floor is cleaned using any of a variety of procedures such as vacuuming with a soft brush to remove dirt and dust. Another cleaning procedure is to dry mop or “tack” the floor in addition to or in lieu of vacuuming. A light spray cleaner may also be applied to the dry mop to help pick up dust and dirt.

The topcoat of the factory finished wooden floor with a nominally flat surface or a sculptured surface is then abraded using the floor abrading machine described herein using a brush with flexible filaments impregnated with medium to fine grit. The operator should look for sufficient “powdering” during the abrasion process. Different types of finish will require different grit sizes and proper selection should be considered on-site. Assume the operator starts out with 120 grit. If there is no powdering, the operator should go to a brush with larger size grit, such as 80. If there is excessive powdering, the operator should go to a brush with smaller size grit, such as 140. When restoring the luster to a first site installed finish, the goal is merely to put small scratches, or abrasions in the first site installed finish, not to remove the finish down to bare wood. As previously mentioned, the small scratches improve adhesion of a fresh coat of finish.

If the topcoat is badly damaged or non-existent, one or more of the intermediate layers of finish may be abraded using the floor abrading machine. The portions of the floor not abraded by the floor abrading machine are then abraded by hand using abrading paper with a suitable abrasive having a grit that is the same as that selected for use with the abrading machine. The portions that have been done by hand are often referred to as “edges”, “wall edges” or “wall lines” in the industry.

The abraded floor surface is then cleaned using any or all of the aforementioned procedures to remove dust and abrasive particles. A fresh intermediate coat of wooden floor finish is then applied to the abraded floor surface and allowed to dry, in accordance with the floor finish manufacturer's instructions, specific to each brand. One or more intermediate coats may be applied followed by abrasion.

After drying, the newly applied intermediate coat is abraded with a brush having fine grit. A new topcoat of finished is applied and allowed to dry. After drying, the luster of the wooden floor has been restored and the floor is ready for use.

Examples 3, 4 and 5 are summarized in Table 3 below.

TABLE 3
Recommended Procedures for Nominally flat & Sculptured Floors

| | | | | | | |
|---|---|---|---|---|---|---|
| Example 3 | Course | Med. | Apply | Apply at | Med.-fine | Apply top |
| Removing factory | grit | grit | stain | least one | grit | coat |
| finish from | | | | intermediate | | |
| nominally flat and | | | | coat | | |
| sculptured floors | | | | | | |
| and refinishing | | | | | | |
| Example 4 | Course | Med. | Apply | Apply at | Med.-fine | Apply top |
| Removing on-site | grit | grit | stain | least one | grit | coat |
| installed finish | | | | intermediate | | |
| from nominally flat | | | | coat | | |
| and sculptured | | | | | | |
| floors and | | | | | | |
| refinishing | | | | | | |
| Example 5 | Course | Med. | Apply | Apply at | Med.-fine | Apply top |
| Removing a | grit | grit | stain | least one | grit | coat |
| combined factory | | | | intermediate | | |
| finish and on-site | | | | coat | | |
| finish from | | | | | | |
| nominally flat and | | | | | | |
| sculptured floors | | | | | | |
| and refinishing | | | | | | |

### Example 3

### Removing a Factory Finish and Applying a First Site Installed Finish

This process is the same for nominally flat surfaced factory finished wooden floors and those having a sculptured finish. Example 3 is summarized in Table 3 above. If the factory finish is badly damaged by wear, sun bleaching and/or water, it may not be possible to restore the luster to the floor as explained in Example 1. If the factory finish is badly damaged, it may be necessary to remove the factory finish and stain down to the bare wood in the thin top veneer so a new finish can be installed on-site. The challenge is to avoid abrading through the thin top wooden veneer.

The floor surface should be cleaned and then be abraded with a brush having flexible filaments impregnated with a course grit. The factory finish and stain should be removed down to bare wood, with care being taken not to wear through the thin top veneer. Then the thin bare wooden veneer should be conditioned using a brush having a medium grit.

Next, a stain should be applied and be allowed to dry according to the manufacturer's directions. Then the first intermediate coat of finish should be applied over the stain and be allowed to dry according to the manufacturer's directions. After drying, the intermediate coat should be abraded with a brush having medium to fine grit. One or more intermediate coats may be applied followed by abrasion. After the at least one intermediate coat has dried and the dust has been removed, a top coat of new finish should be applied. In high traffic areas, several intermediate coats may be applied with abrasion in between each coat.

### Example 4

### Removing a First Site Installed Finish and Applying a Second Site Installed Finish

This process is the same for nominally flat surfaced factory finished wooden floors and those having a sculptured finish. The process of Example 4 is summarized in Table 3. Example 4 assumes that the process of Example 3 has been applied to a factory installed wooden floor. The first site installed finish may be badly damaged by wear, sun bleaching and/or water and it may not be suitable to restore the finish as in Example 2. It may then be necessary to remove and install a second site installed finish. The procedures of Example 3 would then be applied to the first site installed finish and the surface will be refinished.

### Example 5

### Removing a Combined Factory Finish and on-Site Finish that has been Applied According to Example 1

This process is the same for nominally flat surfaced factory finished wooden floors and those having a sculptured finish. The process of Example 5 is summarized in Table 3.

In some situations, the luster will be restored to a factory finished wooden floor according to Example 1. This creates a combined finish having two substantially different characteristics. The upper finish has been applied on-site and typically does not have wear resistant particles therein. The lower finish has been applied by the factory and typically does have wear resistant particles therein. This combined finish may need to be completely removed down to bare wood if it has been badly damaged by wear, sun bleaching and/or water.

The combined on-site finish and underlying factory applied finish are abraded using course grit down to bare wood, taking care not to abrade through the thin top veneer. The bare wood is further abraded by medium grit to smooth the surface. Stain is then applied per the manufacture's directions and allowed to dry. Then at least one intermediate coat of finish is applied per the manufacture's directions and allowed to dry. The at least one intermediate coat is abraded with medium to fine grit. Each intermediate coat must be abraded to ensure good bonding with the following coat. Finally, the top coat is applied and allowed to dry.

FIG. 6 is an end view of a tufted abrading brush 80 with fine grit. A single tuft 82, better seen in FIG. 7, consists of many flexible filaments embedded in a core 86. An outer hub 92 is sized to support the core 86. A counter bore 94 may be formed in the outer hub 92. An aperture 88 is formed in the center of the brush 80 and is sized to slip on the brush drive shaft 60, better seen in FIG. 12. Opposing cutouts 131 are formed in the outer hub 92 and the inner hub, better seen in FIG. 13, to allow the brush 80 to slip over a roll pin 130, better seen in FIG. 12. After the brush wears, it may be removed from the drive shaft and reversed to increase its useful life.

FIG. 7 is a top perspective view of the single tuft 82 from the brush of FIG. 6 with multiple flexible filaments 84 and 90 and other unnumbered flexible filaments. The flexible filaments are not equidistant from the center of the brush. For example, flexible filament 84 is longer than flexible filament 90. Some alternative brush designs such as the one shown in FIGS. 2, 10 and 11 have a population of flexible filaments more-or-less equidistant from the center of the brush. Both the brush design of FIG. 2 and the design of FIG. 6 may be useful in the present invention.

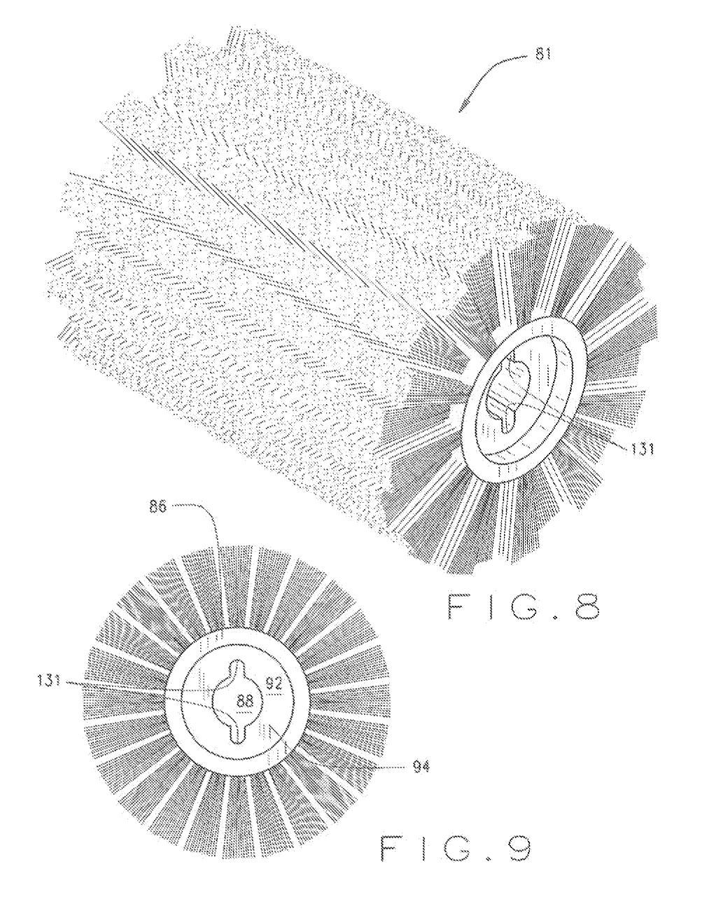

FIG. 8 is a perspective view of a tufted abrading brush 81 with course grit. The primary difference between the brushes 80 and 81 is the size of grit impregnated in the filaments. The brush of FIG. 8 is sometimes referred to as having an irregular trim, which means that the filaments have different lengths. However, after use the filaments wear to a generally even length. After the brush wears, it may be removed from the drive shaft and reversed to increase its useful life.

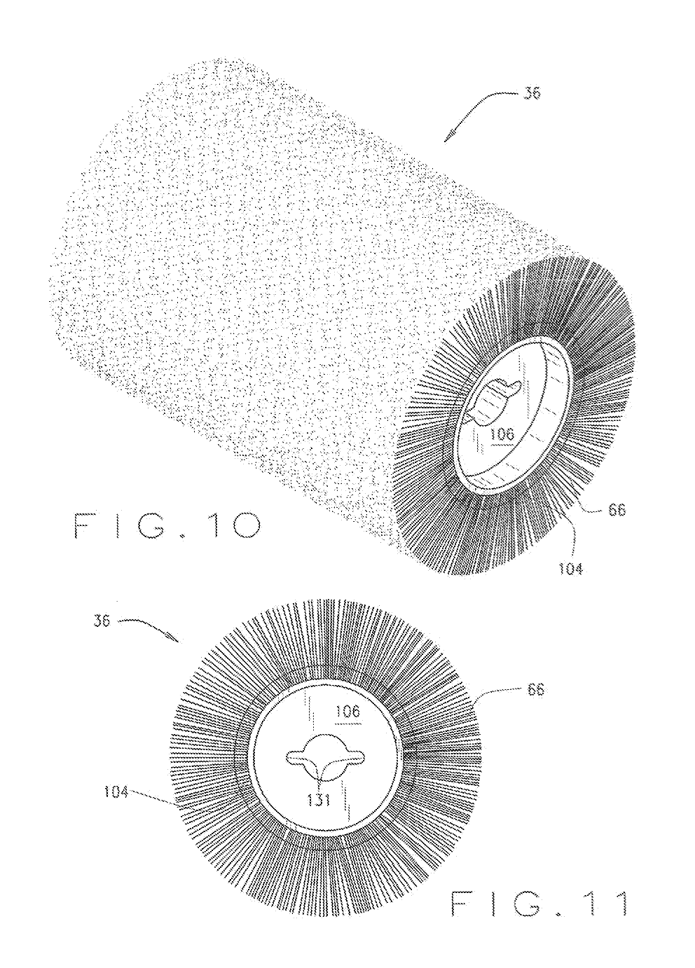

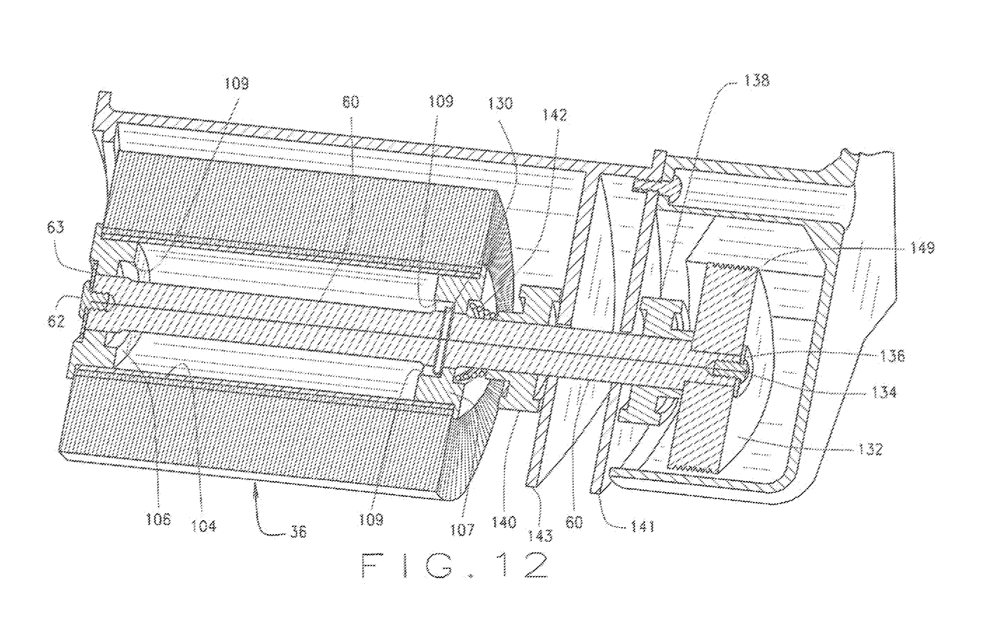

FIG. 9 is and end view of the tufted abrading brush 81 of FIG. 8 with course grit. An outer hub 92 is sized to support the core 86. A counter bore 94 may be formed in the outer hub 92. An aperture 88 is formed in the center of the hub 92 and is sized to slip on the brush drive shaft 60, better seen in FIG. 12. Opposing cutouts 131 are formed in the outer hub and the inner hub 107, better seen in FIG. 13 to allow the brush 81 to slip over a roll pin 130, better seen in FIG. 12.

FIG. 10 is an enlarged perspective view of the abrading brush 36, previously shown in FIG. 2. A plurality of filaments 66 are impregnated with fine grit and are randomly embedded in an outer core 104. An outer hub 106 is sized to fit inside the outer core 104. The outer hub 106 and the outer core 104 may be a single piece or they may be fabricated separately as shown in this drawing.

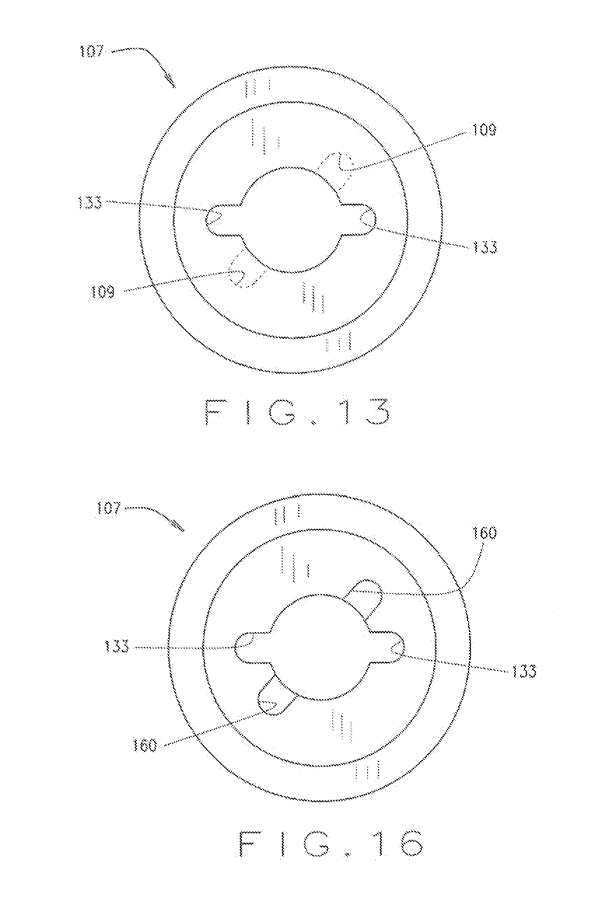

FIG. 11 is an end view of the abrading brush 36 of FIG. 10. Opposing cutouts 131 are formed in the outer hub and the inner hub 107, better seen in FIG. 13, to allow the brush 36 to slip over a roll pin 130, better seen in FIG. 12. After the brush wears, it may be removed from the drive shaft and reversed to increase its useful life.

FIG. 12 is a partial section view of the drive shaft 60 and the abrading brush 36 of FIG. 2. A screw 62 threadably engages one end of the drive shaft 60 to secure the brush 36 in place. A washer 63 may be positioned between the screw 62 and the end of the drive shaft 60. The brush is captured on the drive shaft between the screw and washer 63, on the outer end of the shaft and the spring 142 on the inner end of the shaft. The inner hub 107 has opposing internal pockets 109 formed therein to receive and engage a roll pin 130. These opposing internal pockets are better seen in phantom in FIG. 13. The outer hub 106 likewise has opposing cutouts 131 and opposing internal pockets 109 to allow the brush to be reversed on the drive shaft as it wears. Opposing cutouts 131 allow the inner hub 107 to slip over the roll pin 130. When the drive shaft rotates, it imparts rotation to the roll pin which causes the brush 36 to spin. Opposite the first screw 62 is a second screw 134 which threadably engages the opposite end of the drive shaft. A washer 136 may be positioned between the screw and the driven pully 132. The driven pully 132 is operatively connected by a belt, not shown, or other drive means to the motor, better seen in FIGS. 2 and 3, well known to those in the industry. The drive shaft 60 passes through a first hearing assembly 138 and a second bearing assembly 140. These bearing assemblies are connected to the frame 141 and allow the drive shaft to freely rotate when the motor is running. A spring 142 is captured between the inner hub 107 and second bearing assembly.

FIG. 13 is an end view of the inner hub 107 of FIG. 12, better showing the internal pockets 109 and the opposing cutouts 131 for the roll pin 130.

FIG. 14 is a section view of the brush and drive system similar to FIG. 12, but the brush attaches to a modified drive shaft in a different way. The brush 36 has an outer hub 106 and a modified inner hub 107 with opposing cutouts 131 to allow the brush to pass over the roll pin 130 during installation. The inner hub 107 is modified to form a recess 150 sized and arranged to receive a shoulder 152 formed on the drive shaft 60. The brush 36 is captured between the shoulder 152 on the drive shaft and the screw 63. The roll pin seats in the opposing cutouts 131 in the inner hub 107. When the drive shaft rotates, it rotates the roll pin which engages the opposing cutouts 131 which drive the brush. The outer hub 106 is likewise formed with opposing cutouts 131 to allow the brush to be reversed on the drive shaft.

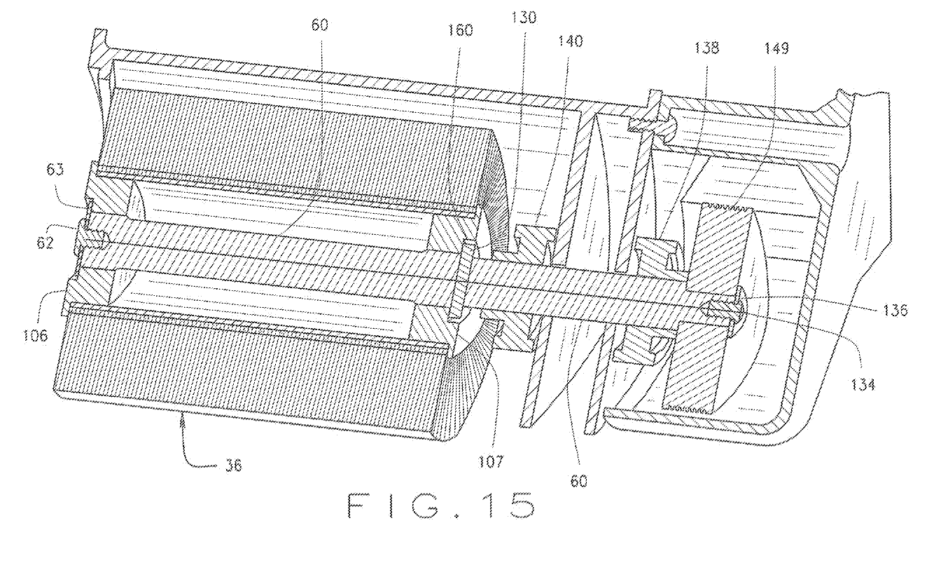

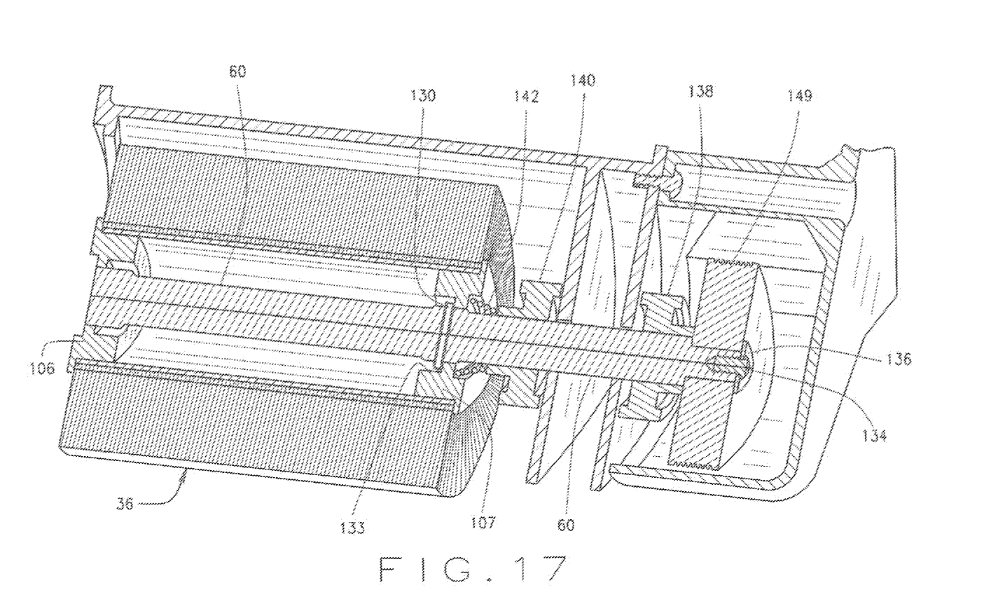

FIG. 15 is a partial section view of the brush and drive system similar to FIG. 13, but the brush attaches to a modified drive shaft in a different way. The brush 36 has a modified outer hub 106 and a modified inner hub 107 both with opposing pockets 160, better seen in FIG. 16, sized and arranged to receive the roll pin 130 which is located in a different position on the drive shaft 60. The brush 36 is captured between the roll pin 130 on the drive shaft and the screw 62 and washer 63. The roll pin seats in the opposing outer pockets 160 in the inner hub 107 and when the brush is reversed, the roll pin seats in the opposing outer pockets in the outer hub 106. When the drive shaft rotates, it rotates the roll pin which engages the opposing outer pockets which drive the brush.

FIG. 16 is an end view of the inner hub 107 of FIG. 15 with the opposing outer pockets 160.

FIG. 17 is similar to FIG. 12 except there is no screw and washer to hold the brush on the drive shaft. This is the easy on-easy off design that does not require tools to remove the brush from the drive shaft. The spring 142 is relatively stiff having a spring force of from about 15 to about 30 pounds, and optimally about 23 pounds. In order to install the brush 36, it is inserted onto the drive shaft so the roll pin slips through the cutouts 131 of the inner hub 107, better seen in FIG. 13. The spring is then compressed and the brush is rotated about 45 degrees to position the roll pin 130 in the inner opposing pockets 109, better seen in FIG. 13. The brush is then released and the force of the compressed spring captures the inner hub 107 between the spring and the roll pin. The outer hub 106 likewise has inner opposing pockets 109 to allow the brush to be reversed on the drive shaft.

What is claimed is:

1. A method for restoring the luster to an existing factory or site installed finish on a wooden floor comprising:
providing or obtaining a brush with flexible filaments having at least one abrasive to condition the surface of the floor to receive and adhere a coat of new finish, the brush having a longitudinal axis;
providing or obtaining a floor abrading machine that is structured to removably receive and drive rotation of the brush, wherein the portable floor abrading machine comprises:
a motor mounted on a machine frame; and
a drive shaft operatively connected to the motor and having a roll pin that is structured for engagement with the brush, the roll pin including first and second opposing pin segments extending radially from an outer surface of the drive shaft;
abrading the existing finish of the floor by rotating the drive shaft to impart rotation to the brush through engagement with the roll pin, wherein the brush rotates substantially perpendicular to the longitudinal axis; and
applying a first coat of new finish to the abraded existing finish to restore the luster to the floor.

2. The method of claim 1 wherein the step of providing or obtaining a brush further comprises installing the brush onto the drive shaft, the brush having an inner hub and first and second opposing cutouts extending through the inner hub to allow the inner hub to slip over the roll pin.

3. The method of claim 2 wherein the step of installing the brush on the drive shaft further comprises engaging the first and second opposing pin segments of the roll pin with first and second internal pockets formed in an internal surface of the inner hub.

4. The method of claim 3 wherein the first and second internal pockets are offset from the first and second opposing cutouts by an offset angle greater than 0 degrees and less than 180 degrees.

5. The method of claim 4 wherein the offset angle is approximately 45 degrees.

6. The method of claim 4 wherein the offset angle is approximately 90 degrees.

7. The method of claim 4 wherein the step of providing or obtaining a floor abrading machine further comprises positioning a spring adjacent to the roll pin and surrounding the drive shaft.

8. The method of claim 7 wherein the step of installing the brush onto the drive shaft comprises:
inserting the brush onto the drive shaft such that the first and second opposing pin segments of the roil pin slip through the corresponding first and second opposing cutouts of the inner hub;
applying an axial force on the brush to compress the spring against the inner hub;
rotating the brush by the offset angle to position the first and second opposing pin segments of the roll pin in the corresponding first and second internal pockets of the inner hub; and
releasing the axial force on the brush to secure the inner hub between the spring and the roll pin.

9. The method of claim 8 further comprising the step of removing the brush from the drive shaft.

10. The method of claim 9 wherein the step of removing the brush from the drive shaft comprises:
applying an axial force on the brush to compress the spring;
rotating the brush by the offset angle to one again position the first and second opposing pin segments of the roll pin in the corresponding first and second opposing cutouts of the inner hub;
releasing the axial force on the brush; and
withdrawing the brush from the drive shaft.

11. The method of claim 1 wherein the abrasive is selected from the group consisting of aluminum oxide, carborundum, quartz, silicon carbide, glass particles, glass beads, glass spheres (hollow and/or filled), plastic grits, diamond dust, hard plastics, reinforced polymers, organics, and mixtures thereof.

12. The method of claim 1 further comprising collecting dust during the abrading of the existing finish.

13. The method of claim 1 further comprising:
linearly abrading the first coat of new finish with the brush to condition the surface to receive and adhere to the next coat of new finish; and
applying a second coat of new finish to the abraded first coat of new finish to restore the luster to the floor.

14. The method of claim 1 wherein abrading the existing finish of the floor by rotating the brush substantially perpendicular to the longitudinal axis comprises rotating the brush clockwise to the longitudinal axis of the brush.

15. The method of claim 1 wherein abrading the existing finish of the floor by rotating the brush substantially perpendicular to the longitudinal axis comprises rotating the brush counterclockwise to the longitudinal axis of the brush.

16. A method for abrading a floor comprising:
providing or obtaining a brush with flexible filaments having at least one abrasive to condition the surface of the floor to receive and adhere a coat of new finish, the brush having an inner hub and a longitudinal axis;
providing or obtaining a floor abrading machine that is structured to removably receive and drive rotation of the brush, wherein the floor abrading machine comprises:
a motor mounted on a machine frame; and
a drive shaft operatively connected to the motor and having a roll pin that is structured for engagement with the brush, the roll pin including first and second opposing pin segments extending from an outer surface of the drive shaft;
installing the brush onto the drive shaft, including sliding the inner hub over the drive shaft and engaging the first and second opposing pin segments of the roll pin with first and second internal pockets formed in an internal surface of the inner hub; and
abrading the floor by rotating the drive shaft to impart rotation to the brush through engagement with the roll pin, wherein the brush rotates substantially perpendicular to the longitudinal axis.

17. A method for abrading a floor comprising:
providing or obtaining a brush with flexible filaments having at least one abrasive to condition the surface of the floor to receive and adhere a coat of new finish, the brush having an inner hub and a longitudinal axis;
providing or obtaining a floor abrading machine that is structured to removably receive and drive rotation of the brush, wherein the floor abrading machine comprises:
a motor mounted on a machine frame; and
a drive shaft operatively connected to the motor and having a roll pin that is structured for engagement with the brush, the roll pin including first and second opposing pin segments extending from an outer surface of the drive shaft;
installing the brush onto the drive shaft, including inserting the brush onto the drive shaft such that the first and second opposing pin segments of the roll pin slip through corresponding first and second opposing cutouts formed in the inner hub, and rotating the brush to position the first and second opposing pin segments of the roll pin in corresponding first and second internal pockets of the inner hub; and
abrading the floor by rotating the drive shaft to impart rotation to the brush through engagement with the roll pin, wherein the brush rotates substantially perpendicular to the longitudinal axis.

18. The method of claim 17 wherein the first and second internal pockets are offset from the first and second opposing cutouts by an offset angle greater than 0 degrees and less than 180 degrees.

19. The method of claim 18 wherein the step of providing or obtaining a floor abrading machine further comprises positioning a spring adjacent to the roll pin and surrounding the drive shaft.

20. The method of claim 19 wherein the step of installing the brush onto the drive shaft further comprises:
applying an axial force on the brush to compress the spring against the inner hub prior to rotating the brush to position the first and second opposing pin segments of the roll pin in the corresponding first and second internal pockets of the inner hub; and
releasing the axial force on the brush to secure the inner hub between the spring and the roll pin.
